(19) United States
(12) Patent Application Publication
(10) Pub. No.: US 2017/0232985 A1
(43) Pub. Date: Aug. 17, 2017

(54) DECORATIVE TREE STORAGE CONTAINER

(71) Applicant: Shining Sea Trading Company, West Valley City, UT (US)

(72) Inventor: Jared Hendricks, Draper, UT (US)

(73) Assignee: Shining Sea Trading Company, West Valley City, UT (US)

(21) Appl. No.: 15/361,344

(22) Filed: Nov. 25, 2016

Related U.S. Application Data
(60) Provisional application No. 62/259,503, filed on Nov. 24, 2015.
(60) Provisional application No. 62/347,383, filed on Jun. 8, 2016.

(51) Int. Cl. B62B 1/26; B62B 1/18; A45C 5/14; A45C 13/02; B65D 85/00; A45C 5/02

(52) U.S. Cl. CPC B62B 1/262; B65D 85/54; A45C 5/02; A45C 5/14; A45C 13/02; B62B 1/18; B62B 2202/70

(57) ABSTRACT

A decorative tree storage container including an enclosure having a proximal end, a distal end, and an underside surface, is provided, and described. The storage container can be sized to hold a decorative tree, and can include one or more wheels coupled to the enclosure and positioned at a wheel location between the proximal end and the distal end that increases the clearance between the underside surface of the enclosure and a supporting surface when a decorative tree is in the enclosure and a user is lifting the proximal end by the handle.

### RELATED APPLICATION

This application claims the benefit of U.S. Provisional Patent Application Ser. No. 62/259,503, filed Nov. 24, 2015, and U.S. Provisional Patent Application Ser. No. 62/347,383, filed Jun. 8, 2016, each of which is incorporated herein by reference.

### BACKGROUND

Many households utilize storage containers for gathering and storing a variety of household, as well as personal items. Examples of such items may include: clothing, toys, memorabilia, seasonal items, and decorations. In some cases, items can be stored in order to provide a more structured organization to an environment, and thus may be frequently accessed. In other cases, items can be stored that are infrequently used, and the storage container can provide protection to the items from damage, decay, dust, moisture, and the like.

Storage containers come in a variety of sizes and shapes, and a consumer generally finds a container to purchase that has an appropriate size and shape to hold the item or items to be stored. Many containers include mostly open space for storage, while others have compartments to separate items. To ensure that the size and shape of the container are appropriate for the intended use, a user will generally obtain a storage container with a specific use in mind; but not every storage problem has a container specifically designed for a particular use.

### BRIEF DESCRIPTION OF THE DRAWINGS

FIG. 1A is a side view of a storage container in accordance with an example embodiment;

FIG. 1B is an isometric view of a storage container in accordance with an example embodiment;

FIG. 1C is an isometric view of a storage container in accordance with an example embodiment;

FIG. 2 is an isometric view of an axle and wheels for a storage container in accordance with an example embodiment;

FIG. 3 is a side view of a storage container in accordance with an example embodiment; and

FIG. 4 is an isometric view of a storage container in accordance with an example embodiment.

### DETAILED DESCRIPTION

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. Also, the same reference numerals in appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall concepts articulated herein, but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

As used herein, “coupled” refers to a relationship of some form of connection or attachment between one item and another item, and includes relationships of either direct or indirect connection or attachment. Any number of items can be coupled, such as materials, components, structures, layers, devices, objects, etc.

As used herein, “directly coupled” refers to a relationship of physical connection or attachment between one item and another item where the items have at least one point of direct physical contact or otherwise touch one another. For example, when one layer of material is deposited on or against another layer of material, the layers can be said to be directly coupled.

As used herein, “indirectly coupled” can define a relationship between to items or objects that are physically connected to one another through a shared or common such that they are not in direct contact with each other. For example, when one object is tied to another object with a string, the objects can be said to be indirectly coupled.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

### Example Embodiments

An initial overview of technology embodiments is provided below and specific technology embodiments are then described in further detail. This initial summary is intended to aid readers in understanding the technology more quickly, but is not intended to identify key or essential features of the technology, nor is it intended to limit the scope of the claimed subject matter.

The present disclosure relates to a device for storing and/or transporting various items. In one aspect, the device can be used to store and/or transport a decorative tree. One specific example of such a tree is a Christmas or other holiday tree. With respect to trees, it is noted that the present disclosure is not limited to holiday trees or the like, but rather the present scope extends to any type of tree that is capable of being stored. More broadly, the present device could be utilized to store or transport other items. It is therefore noted that while the present disclosure describes primarily the storage and transport of decorative trees, the breadth of the present scope should not be limited to the storage and transport of decorative trees.

One problem that can arise in the transportation and storage of items such as decorative trees in a storage container having wheels at one end, involves the weight of the tree negatively impacting on the functionality of the storage container. For example, the weight of a tree can flex the storage container, bind the wheels, flex or bend the wheel axle, and the like. In some cases, these negative effects can be compounded for taller people due to the distance to which one end of the container is raised during use. Assuming the taller person stands up straight, the distance to a handle of the container will be greater than for a shorter person, which can cause greater flexion in of the container as well as a greater force impinging on the wheels to increase binding. The present disclosure mitigates these negative effects, at least in one example, by designing the container to account for the flexing, binding, etc. generated by the weight of the tree.

For example, the present disclosure can relate to a storage container that generally includes an enclosure or housing and at least one wheel or other movement mechanism. Furthermore, the overall design of the container can include one or more features to reduce a negative effect due to the weight of the decorative tree, such as, for example, placement of the wheels inward from the distal end, use of large wheel sizes, use of a wheel well, use of a tapered segment on an underside surface at the distal end, use of a predetermined flexion feature, or a combination thereof.

In further detail, a decorative tree storage container can include an enclosure having a proximal end, a distal end, and an underside surface. The enclosure can be sized to hold a variety of decorative trees of different sizes and shapes. While any size of tree is contemplated, in one example enclosures can typically be sized to hold decorative trees ranging in height from about 3 feet or 4 feet to about 9 feet or 10 feet, or more. In some specific nonlimiting examples, the enclosure can be sized to hold decorative trees ranging in height from about 4 feet to about 6 feet, from about 6 feet to about 7.5 feet, from about 7.5 feet to about 9 feet, and the like.

Further, enclosures can typically be sized to hold decorative trees ranging in diameter from about 12 inches or less to about 84 inches, or more. In some specific examples, the enclosure can be sized to hold decorative trees having a diameter of about 18 inches or less, about 55 inches or less, or about 72 inches or less. It is noted that, in some cases, the diameter of the decorative tree can be compressed to a diameter that is from about 30% to 90%, or about 40% to about 70% of an expanded diameter of the decorative tree. Compressing the diameter of the decorative tree can be useful during storage and/or transportation of the decorative tree with the decorative tree storage container. In some examples, the enclosure can be sized to hold a decorative tree with a compressible diameter of about 12 to 18 inches or less, about 24 to 30 inches or less, or about 36 to 42 inches or less.

The enclosure can be made of any material capable of enclosing or containing items, including, without limitation: fibers, textiles, cloths, fabrics, papers, polymeric materials, various plastic polymers, natural and synthetic rubbers, woods, metals, metal alloys, and the like, including appropriate combinations thereof. Specific non-limiting examples can include polyester, nylon, polyethylene, polypropylene, cotton, linen, leather, canvas, and the like, including combinations thereof. As noted above, the enclosure can have a variety of configurations depending on the design and intended storage use. Non-limiting examples can include a bag, a box, a basket, a crate, a chest, or other appropriate structures. Thus, in some examples, the enclosure can be made of a rigid material. In yet other examples, the enclosure can be made of a flexible material, such as a fabric material.

In some aspects, one or more wheels can be positioned at a location (i.e., the wheel location) between the proximal end and the distal end of the enclosure. The wheel location can be positioned inward from the distal end at a point that increases the clearance between the underside surface of the enclosure and a supporting surface from the wheel location to the proximal end when a decorative tree is in the enclosure and when a user is lifting the proximal end. In one example, the wheel location is positioned at or near the flexion point created by lifting the proximal end, and thus the wheels support the enclosure and the tree at the point where such flexion point would contact the supporting surface if the wheels were located at the distal end. Thus, the one or more wheels of the container are positioned on the device so as to contact the supporting surface upon which the portable container is placed while minimizing contact of the enclosure with that surface.

A variety of wheels, wheel designs, and wheel sizes can be used with the current container designs. In some aspects, the wheels can include tires. Where tires are used, the tires can be solid, tubeless, or can be supported by an inner tube. In other aspects, the wheels can be discs, castors, spheres, or any other possible wheel design. Further, a variety of wheel designs can be used with various container designs. In one aspect, the wheels can be adapted for opposing lateral placement at one or more wheel locations along the length of the enclosure. In additional examples, one or more wheels can be configured for placement across the width of the container between two laterally-placed wheels.

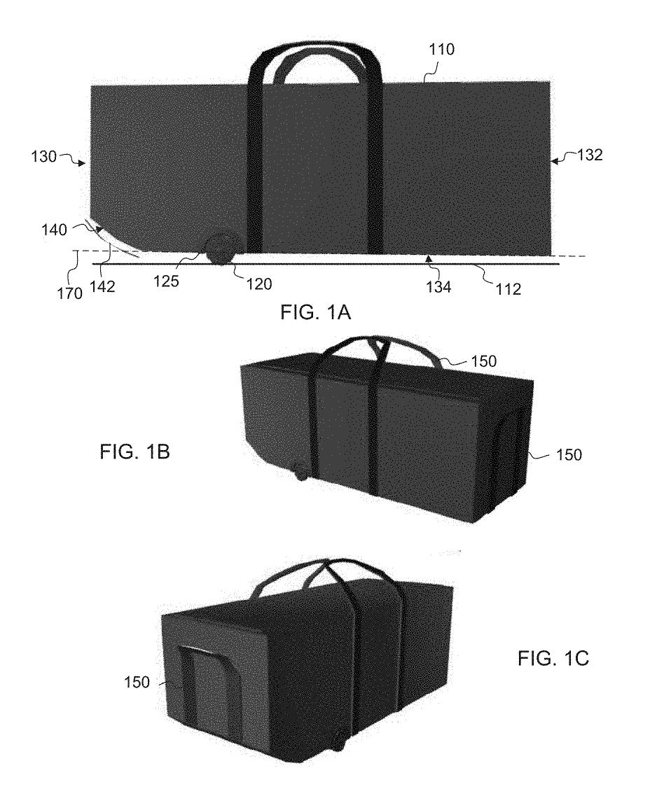

Placement of the wheels relative to the enclosure, as well as the size and configuration of the wheels, can greatly impact the extent to which the enclosure of the container contacts a supporting surface, such as a floor, for example. As can be seen in FIGS. 1A-C, for example, a storage container can include an enclosure 110 and one or more wheels 120. However, if the wheels 120 are positioned too close to the distal end 130 or too close to the proximal end 132 of the enclosure 110, the underside surface 134 of the enclosure 110 can contact the supporting surface 112, particularly when being lifted from the proximal end. Such supporting surface-contact can make handling of the container somewhat challenging for a user, as the majority of the weight of the tree is not resting on the wheels. In addition to the weight of the decorative tree creating movement and handling difficulties through friction at the point of contact with the supporting surface, contact between the surface and the enclosure can result in damage to the tree or other cargo inside the container.

The presently disclosed technology minimizes or even eliminate contact of the underside surface 134 of the enclosure 110 with the supporting surface 112 by positioning one or more wheels 120 at a wheel location between the proximal end 132 and the distal end 130. Such positioning provides adequate clearance between the underside surface 134 and the supporting surface 112 from the wheel placement at the wheel location to the proximal end 132 when a user is lifting the proximal end 132.

A variety of handles 150 can be coupled to the enclosure 110, such as at the proximal end 132 as illustrated in FIG. 1B, at the distal end 130 as illustrated in FIG. 1C, or at various locations between the proximal end 132 and the distal end 130. The handles 150 can facilitate lifting or otherwise maneuvering the storage container.

In further detail with respect to wheel placement, the wheels can be placed at a distance from the distal end of the container or enclosure of from about 5% or 10% to about 20% or 25% of the total length of the underside surface. In additional examples, the wheel location can be positioned at a distance from the distal end of the enclosure of from about 10% to about 15% of the total length of the underside surface. Of course, placement of the wheels can depend on a variety of factors, such as the various dimensions of the container or enclosure, the type of enclosure employed, the weight and/or weight distribution of the cargo, the degree of lifting of the container, the physical dimensions of the wheel, the design of an axle, and the like. In one aspect, the one or more wheels can be placed at a plurality of wheel locations along the length of the container. Further, one or more wheels can be placed at a distance from the distal end of the container of from about 5% to about 25% of the total length of the underside surface while one or more additional or supplemental wheels can be placed at any other suitable length along the enclosure, including at the distal end, at or near the proximal end, or a combination thereof.

It is noted that, in some example embodiments, the mere placement of the one or more wheels inward from the distal end may improve, but not eliminate, contact between the underside surface and the supporting surface. For example, in some embodiments whereby the storage container includes an enclosure that is not self-supporting, the wheel location can be positioned to preclude contact between the underside surface and the supporting surface. In other embodiments, an enclosure that is not self-supporting can still experience some supporting surface contact due to the enclosure sagging down between the wheel location and the proximal end. Contact can also occur between the enclosure and the wheels, thus further reducing the usefulness of the wheels. Accordingly, in some examples the storage container can include a variety of features to further reduce or prevent contact of the enclosure with the support surface, and to reduce or prevent the enclosure from contacting the one or more wheels.

In some examples, a larger wheel sizes can allow the container to roll more easily by further minimizing contact between the underside surface of the enclosure and the supporting surface. Wheel sizes can also be adjusted based on the dimensions of the container, placement of the wheels, container type, cargo type, cargo weight and/or weight distribution, and the like. While any storage container design can include larger wheel sizes, in one embodiment a storage container that is not self-supporting can benefit from larger wheels. In some specific examples, a wheel can have a diameter ranging from about 7 centimeters (cm) to about 25 cm, or from about 10 cm to about 15 cm or 20 cm. While these wheel sizes can be suitable for some designs, other enclosures can benefit from either larger or smaller wheel sizes.

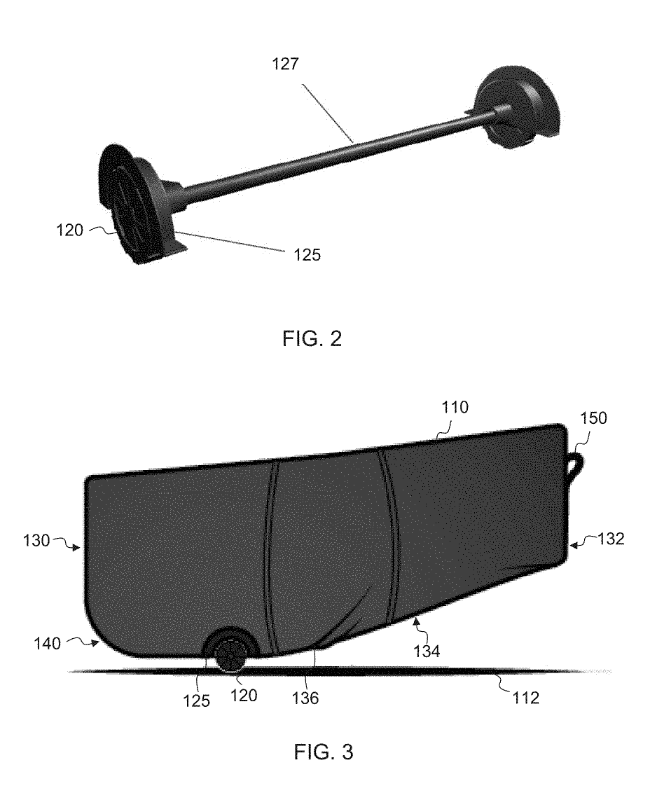

In some examples, as illustrated in FIG. 1A and FIG. 2, the wheels 120 can be adapted to be used in connection with wheel wells 125 and/or coupled to an axle 127 (see FIG. 2). Wheel wells 125 can block the enclosure from contacting the wheels 120. In some examples, the wheel well 125 can be positioned along the underside surface 134 of the enclosure 110 and can be is adapted to open toward the supporting surface 112, but not toward the distal end 132. In yet other examples, the wheel well 125 can be adapted to open toward the supporting surface 112 and also toward the distal end 130 in order to preclude contact between the wheel well and the supporting surface at a broader range of lift angles when the storage container is lifted from the proximal end 132.

Further, various axle configurations can be used, such as axle 127, shown in FIG. 2. For example, a straight dead axle, a straight dead axle that employs a plurality of supplementary support rods, or any other suitable axle can be used. It is noted that the axle can also employ a variety of geometries other than being straight. Additionally, various numbers of support rods, platforms, frames, and the like can be used in connection with the axle.

In another example, the storage container can include a tapered segment or section between the wheel location and the distal end of the container. As is shown in FIGS. 1A-C and 3, the underside surface 134 of the enclosure 110 can extend substantially along a plane 170 from the proximal end 132 to at least the wheel location. Depending on the design of the storage container, a tapered segment 140 can be formed from a point that is distal to the wheel location to the distal end 130 of the enclosure 110. The underside surface 134 can form the tapered segment 140 extending away from the plane 170 and the supporting surface 112 toward the distal end 130. The tapered segment 140 is designed to provide clearance between the supporting surface 112 and the distal end 130 of the enclosure 110 when the storage container is lifted from the proximal end 132. In some examples, the tapered segment 140 can be reinforced by an internal or external support member 142, or a combination thereof. The support member can be a liner, a frame, a rigid portion of the external covering, or other suitable support member.

In some examples, the storage container can also include a support frame coupled to and supporting the enclosure. The support frame can be internal, external, or a combination thereof, which can include a supportive structure that is integrated into the enclosure. The support frame can provide support for the entire container or specific portions or sections of the container. In some aspects, the enclosure can include a rigid or semi-rigid portion that provides at least some structural support to the container.

In some storage container designs, the support frame can be positioned inside of the enclosure. In some examples, the wheels can be coupled to the support frame in the absence of an axle, while in other examples the wheels can be coupled to an axle. Coupling the wheels to an axle that is also coupled to an internal support frame can provide added stability to the storage container. In one example design, either a portion of the internal support frame or the axle extends through the enclosure to operably coupled with a pair of laterally-position wheels. Such a configuration creates added stability to the enclosure due to the internal positioning of the support frame, while at the same time allowing the wheels to function more effectively position outside of the enclosure. In another example, the internal support frame extends through the enclosure and couples with the axle, which is positioned outside of the enclosure. In another example, the axle can be located partially within the enclosure along the middle section of the axle, and partially outside of the enclosure door the axle ends. In such cases, the internal support can extend through the enclosure to couple with the axle. In yet other examples, the internal support can extend through the enclosure and form the axle for the wheels. It is additionally contemplated that, in some embodiments, wheel wells can be associated with wheels, and the internal support frame can extend through the enclosure to engage with the will wells.

In some examples, the support frame can be a planar or non-planar frame positioned along at least one side of the storage container, and can be realized in a variety of physical configurations. The support frame can be square, rectangular, cylindrical, trapezoidal, arched, or any other geometrical shape. Additionally, different sides of the support frame can have different geometrical configurations, depending on the design and use of the storage container. The support frame can be made of any material capable of supporting the enclosure, and all such materials are considered to be within the present scope. Non-limiting examples can include: metals, metal alloys, woods, rubber materials, graphite, ceramics, polymeric materials including plastics, and the like, including appropriate combinations and composites thereof.

In one specific example, the support frame can form a rectangle including a combination of horizontal and vertical members coupled together to form the rectangular shape. The horizontal and vertical members can be permanently coupled together to form the support frame, or at least a portion of the members can be detachable to allow the support frame to be disassembled.

In another example, the support frame can be secured to the enclosure, for example by sewing or otherwise attaching the support frame directly to the enclosure. In yet another aspect the frame can be secured to the enclosure with fasteners, such as, without limitation, buttons, ties, snaps, clips, glue, hook and loop devices, and the like. In yet another aspect, the frame can be threaded through holes in the enclosure.

In another aspect, the frame can be disassembled, compacted, or otherwise reduced in size, either separately from or in association with the enclosure. Various interlocking members, segments, hinges, and other devices are contemplated to facilitate assembly and disassembly of the storage container. Such devices allow members of the support frame to be secured together to form the support frame. In other aspects the support frame can include flexible materials, and thus can be folded, compressed, coiled, or otherwise bent to reduce the size of the frame. By reducing the size of the support frame, the necessary storage requirements of the storage container can be minimized when not in use. This allows for easy transport and placement of the empty storage container.

As illustrated in FIG. 3, in another embodiment of the storage container, the enclosure 110 can have a predetermined flexion feature 136. The flexion feature 136 can allow the enclosure 110 to bend or bow at a predetermined position along the enclosure 110 length. This can allow a portion of the weight of the cargo to be transferred from the wheels 120, and in some cases the axle, to an end user. This can help overcome some of the structural challenges associated with carrying heavy cargo in the current container. Additionally, flexing of the enclosure can further allow an individual to straighten to an upright position while lifting the weight of the tree in a manner that minimizes back-related lifting injuries. The flexion feature 136 can be made using a hinge, a joint, a spring, a gap in an internal or external support member or frame, or via use of a less rigid material, and the like. The flexion feature 136 can also be created by only extending a support member or frame partially from the distal end to the proximal end of the container, thus forming the flexion feature 136 near the end point of the support member or support frame.

The flexion feature can be positioned at various locations along the container. Exact placement of the flexion feature can be based on a variety of factors, such as dimensions of the bag and/or cargo, weight and/or distribution of weight of the cargo, degree of lifting of the proximal end of the container, and the like. In some specific examples, the flexion feature can be positioned at a distance from the proximal end ranging from about 25% to about 45% of the total length of the container. In yet other examples, the flexion feature can be positioned at a distance from the proximal end ranging from about 35% to about 45%, from about 30% to about 40%, or from about 25% to about 35% of the total length of the container.

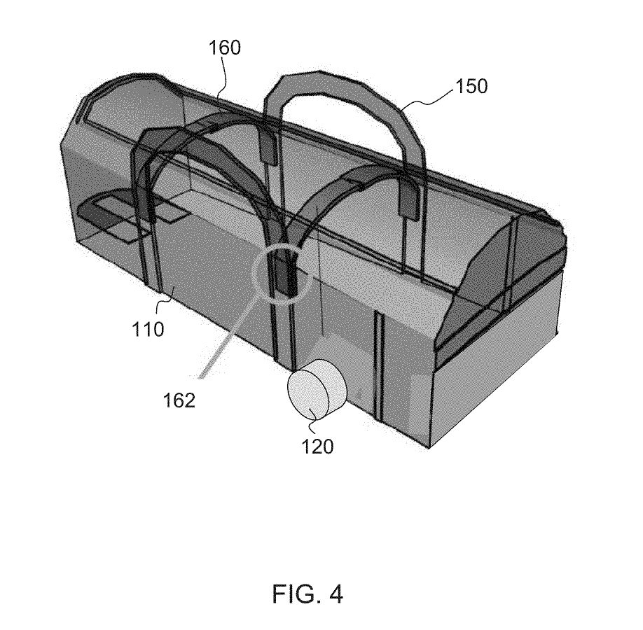

The storage container can include, in one embodiment as illustrated in FIG. 4, a cargo stabilizer, such as one or more internal compression straps 160, webbing, fasteners, or the like, including combinations thereof. Where the cargo stabilizer includes internal compression straps, in some examples, the internal compression straps can be attached to one or more handles 150 at an attachment point 162. In another embodiment, a cargo stabilizer can include an inner layer of webbing to help compress or secure the cargo inside the storage container. In yet another aspect, the cargo stabilizer can include other internal fasteners that allow items to be secured within the container. Any cargo stabilizer can be strategically placed, and may be secured to either the container or a support frame. Cargo stabilizers can be operable such that they prevent items within the container from jostling about. In yet another aspect, the storage container can contain external fasteners. External fasteners can be operable to allow the bag to be opened and securely closed.

A decorative tree storage system can include a storage container as described herein and a decorative tree positioned in the storage container. In some examples, the tree can be a holiday tree, such as a Christmas tree or other suitable holiday tree. Where the decorative tree is a Christmas tree, in some examples, the Christmas tree can be pre-furnished with decorative lighting, ornaments, or the like. Further, in some examples, the decorative tree can include a tree stand, pot, or the like, that can be part of the storage container or separate from the storage container. In some additional examples, the tree can be disassembled and placed into the enclosure of the storage container. In yet additional examples, the tree can be compressed to a smaller diameter and placed into the enclosure of the storage container.

Further the decorative tree storage container can be used in a method of storing and/or transporting a tree, such as a decorative tree. The storage container can be tipped onto the wheels of the container and rolled along the ground or other support surface to a desired location for storage or display of the tree.

Of course, it is to be understood that the above-described arrangements are only illustrative of the application and of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been described above with particularity and detail in connection with what is presently deemed to be the most practical embodiments of the disclosure, it will be apparent to those of ordinary skill in the art that numerous modifications, including, but not limited to, variations in size, materials, shape, form, function and manner of operation, assembly and use may be made without departing from the principles and concepts set forth herein.

1. A decorative tree storage container, comprising:
an enclosure having a proximal end, a distal end, and an underside surface, where the enclosure is sized to hold a decorative tree;
one or more wheels coupled to the enclosure;
a handle coupled to the proximal end;
wherein the one or more wheels are positioned at a wheel location between the proximal end and the distal end that increases the clearance between the underside surface of the enclosure and a supporting surface from the wheel location to the proximal end when a decorative tree is in the enclosure and a user is lifting the proximal end by the handle.

2. The container of claim 1, further comprising a support frame coupled to and supporting the enclosure.

3. The container of claim 2, wherein the support frame is positioned inside of the enclosure, and wherein the support frame extends through the enclosure to operably couple to at least two of the one or more wheels positioned outside of the enclosure.

4. The container of claim 2, further comprising a wheel well attached to and supported by the support frame to prevent the external covering from contacting a wheel.

5. The container of claim 2, further comprising an axle attached to the support frame and operatively connected to the one or more wheels.

6. The container of claim 1, wherein the wheel location is at a distance from the distal end that minimizes contact between the underside surface of the enclosure and the supporting surface when the user is lifting the proximal end by the handle.

7. The container of claim 1, wherein the external covering comprises a fabric material selected from the group consisting of polyester, nylon, polyethylene, polypropylene, cotton, linen, leather, and combinations thereof.

8. The container of claim 1, further comprising a tapered segment at the distal end, structurally configured to preclude contact between the underside surface and the supporting surface at the distal end when the proximal end of the storage container is lifted.

9. The container of claim 1, wherein the tapered segment further comprises a support member to structurally reinforce the tapered segment, the support member being a liner, a frame, a rigid portion of the enclosure, or a combination thereof.

10. The container of claim 1, further comprising an additional handle attached to an exterior surface of the enclosure between the proximal end and the distal end.

11. The container of claim 1, further comprising a cargo stabilizer disposed within the enclosure to stabilize cargo during use.

12. The container of claim 1, further comprising a predetermined flexion feature positioned along the underside surface.

13. The container of claim 12, wherein the predetermined flexion feature is positioned at a distance from the proximal end ranging from 25% to 45% of a total length of the container.

14. The container of claim 1, comprising a plurality of wheels.

15. The container of claim 1, wherein the one or more wheels have a wheel size that precludes contact between the underside surface and the support surface when a user is lifting the proximal end by the handle.

16. The container of claim 15, wherein the one or more wheels have a diameter ranging from 7 centimeters (cm) to 25 cm.

17. The container of claim 1, wherein the wheel location is spaced from the distal end at a distance ranging from 5% to 20% of a total length of the container.

18. A decorative tree storage system, comprising:
the decorative tree storage container of claim 1; and
a decorative tree positioned in the storage container.

19. The system of claim 18, wherein the decorative tree is a holiday tree.

20. The system of claim 19, wherein the holiday tree is a Christmas tree.
